(19) United States
(12) Patent Application Publication
(10) Pub. No.: US 2010/0098960 A1
(43) Pub. Date: Apr. 22, 2010

(54) MAGNETIC INSULATOR NANOLAMINATE DEVICE FOR INTEGRATED SILICON VOLTAGE REGULATORS

(76) Inventors: Juan E. Dominguez, Hillsboro, OR (US); Arnel M. Fajardo, Beaverton, OR (US); Adrien R. Lavoie, Beaverton, OR (US)

Correspondence Address: INTEL CORPORATION;c/o CPA Global, P.O. BOX 52050, MINNEAPOLIS, MN, 55402, US

(21) Appl. No.: 11/764,539

(22) Filed: Jun. 18, 2007

(51) Int. Cl. B32B 15/04; B05D 5/12

(52) U.S. Cl. 428/469; 427/97.1

(57) ABSTRACT

A magnetic insulator nanolaminate device comprises a metal magnetic layer formed on a substrate, an insulating layer formed on the metal magnetic layer, wherein the insulating layer is formed by nitriding a portion of the metal magnetic layer, a chelating group layer formed on the insulating layer, and a metal seed layer bonded to the chelating group layer. The magnetic insulator nanolaminate device may be formed by depositing a metal layer on a substrate, converting a portion of the metal layer into an insulating layer using a nitridation process, and depositing a metal seed layer onto the insulating layer using a metal immobilization process, wherein the metal seed layer enables the deposition of a metal layer onto the insulating layer.

### BACKGROUND

In the manufacture of integrated circuit devices, voltage regulators are generally located separate from the integrated circuit die. On die voltage regulators, known as integrated silicon voltage regulators (ISVR), are highly desired. However, issues such as eddy currents tend to appear in conventional metal magnetic films used for ISVR, thereby causing reliability issues.

Conventional off-die voltage regulators tend to be relatively large and consume considerable power. Off-die voltage regulators are also slow relative to ISVR devices due to impedance caused by the length of the connection to the integrated circuit transistors. This slowness causes a bottleneck as integrated circuit devices are made smaller and faster. Accordingly, improved ISVR devices are needed to reduce eddy currents and eliminate the need for off-die voltage regulators.

### BRIEF DESCRIPTION OF THE DRAWINGS

FIG. 1 is a method of forming a magnetic insulator nanolaminate device in accordance with an implementation of the invention.

FIGS. 2A to 2E illustrate structures that are formed when the method of FIG. 1 is carried out.

FIG. 3 illustrates an exemplary chelating group.

FIG. 4 illustrates how the magnetic insulator nanolaminate device of the invention may be used to form an integrated silicon voltage regulator.

### DETAILED DESCRIPTION

Described herein are systems and methods of forming a magnetic insulator nanolaminate device for integrated silicon voltage regulator (ISVR) applications. In the following description, various aspects of the illustrative implementations will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative implementations. However, it will be apparent to one skilled in the art that the present invention may be practiced without the specific details. In other instances, well-known features are omitted or simplified in order not to obscure the illustrative implementations.

Various operations will be described as multiple discrete operations, in turn, in a manner that is most helpful in understanding the present invention, however, the order of description should not be construed to imply that these operations are necessarily order dependent. In particular, these operations need not be performed in the order of presentation.

Implementations of the invention provide structures and fabrication methods for a magnetic insulator nanolaminate device for ISVR applications. The magnetic insulator nanolaminate device of the invention consists of multiple magnetic layers separated by insulating layers. The methods of the invention enable magnetic layers to be deposited on insulating layers. The magnetic insulator nanolaminate device of the invention improves device response time, increases the number of power states, and provides low impedance access to transistors of the integrated circuit device.

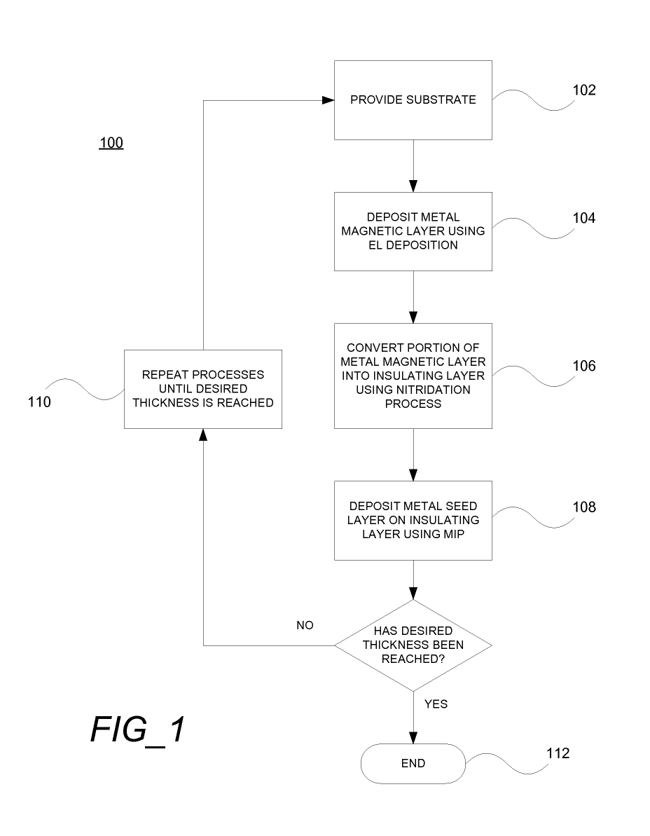

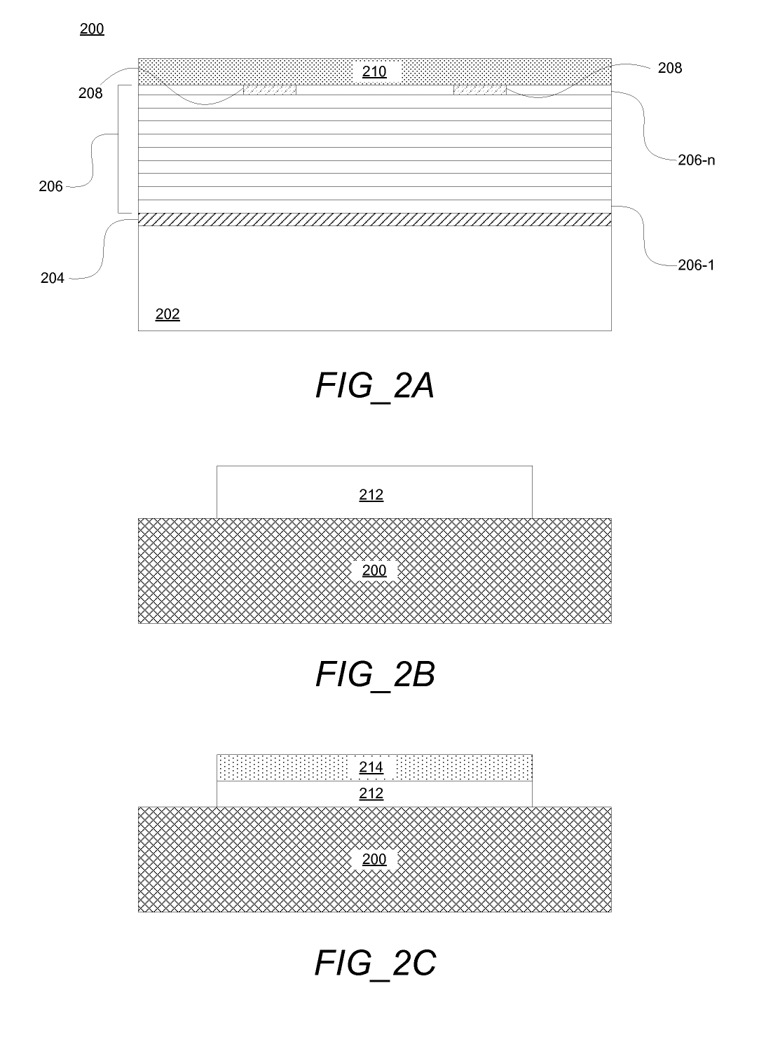

FIG. 1 is a method 100 of forming a magnetic insulator nanolaminate device in accordance with an implementation of the invention. FIGS. 2A to 2E illustrate structures that are formed when the method 100 of FIG. 1 is carried out.

The method 100 of FIG. 1 begins by providing a substrate upon which a magnetic insulator nanolaminate device is to be fabricated (process 102 of method 100). The substrate is generally a passivated integrated circuit die upon which an ISVR is to be formed. After fabrication, the magnetic insulator nanolaminate device may be used in forming the ISVR.

FIG. 2A is a detailed illustration of an integrated circuit (IC) die 200 that serves as a substrate for the magnetic insulator nanolaminate device. Generally, the IC die 200 is built on a semiconductor substrate 202. The substrate 202 is generally formed using a bulk silicon or a silicon-on-insulator substructure, although it may be formed using materials such as germanium, indium antimonide, lead telluride, indium arsenide, indium phosphide, gallium arsenide, or gallium antimonide, any of which may be combined with silicon.

A top surface of the substrate 202 provides a device layer 204 upon which transistors, as well as other devices such as capacitors and inductors, may be formed. Above the device layer 204 are multiple metallization layers 206-1 through 206-n, where n represents the total number of metallization layers. Conventional IC dies can have as few as one metallization layer to as many as ten metallization layers, although greater than ten metallization layers are also possible. Each metallization layer 206 includes metal interconnects, generally formed of copper, as well as vias that electrically couple metal interconnects across various metallization layers. Each metallization layer 206 also includes interlayer dielectric (ILD) material surrounding and insulating the metal interconnects and the vias. ILD materials that may be used include, but are not limited to, silicon dioxide (SiO₂), carbon-doped oxide (CDO), silicon nitride (SiN), organic polymers such as perfluorocyclobutane (PFCB), or fluorosilicate glass (FSG).

On the final metallization layer 206-n are a number of bond pads 208. One or more interconnects of the metallization layers 206 terminate at the bond pads 208, which are generally formed of copper, aluminum, or alloys thereof. A passivation layer 210 is formed above the metallization layers 206 to seal and protect the IC die 200 and the metallization layers 206 from damage and contamination. The passivation layer 210 may be formed from many different materials, including but not limited to silicon nitride (SiN), oxynitride, polyimide, and certain polymers. As is known in the art, openings may be formed in the passivation layer 210 to expose the bond pads 208.

Returning to FIG. 1, an electroless plating deposition process is used to deposit a cobalt or nickel metal alloy magnetic layer upon the passivation layer of the IC die (104 of FIG. 1). In implementations of the invention, the magnetic layer may have a weight fraction of either cobalt or nickel that is at least around 70%. In some implementations, the magnetic layer may include both cobalt and nickel, and the combined weight fraction of the cobalt and nickel in the magnetic layer may be at least around 70%. The remainder of the magnetic layer consist of alloying elements that include, but are not limited to, iron, tungsten, molybdenum, boron, phosphorus, sulfur, and carbon.

As is known in the art, electroless (EL) plating is a metal deposition process in which the metal ions are dissolved in solution and a controlled chemical reduction reaction is used to deposit the metals onto a substrate. The electroless process is autocatalytic as the metals being deposited catalyze the chemical reduction reaction without the need for an external electric current. Electroless plating is a selective deposition and occurs at activated locations on the substrate surface, i.e., locations that have a nucleation potential for an electroless plating solution. In accordance with implementations of the invention, the electroless plating process may be carried out for a sufficient time to form a magnetic layer having a thickness between around 2 nanometers (nm) and around 500 nm. Again, the magnetic layer may be a cobalt metal alloy layer, a nickel metal alloy layer, or a combined cobalt and nickel metal alloy layer.

In implementations of the invention, an electroless plating solution used in the electroless plating process may include water, a water soluble compound containing the metal to be deposited (e.g., a cobalt or nickel metal salt), a complexing agent (e.g., an organic acid or amine) that prevents chemical reduction of the metal ions in solution while permitting selective chemical reduction on a surface of the target, and a chemical reducing agent for the metal ions (e.g., hypophosphite, dimethylaminoborane (DMAB), formaldehyde, hydrazine, or borohydride). Additionally, the plating solution may include a buffer (e.g., boric acid, an organic acid, or an amine) for controlling pH and various optional additives, such as solution stabilizers (e.g., pyridine, thiourea, or molybdates), surfactants (e.g., a glycol), and wetting agents. It is to be understood that the composition of a plating solution will vary depending on the desired plating outcome.

If needed, the surface of the substrate, such as the surface of the passivation layer, may be prepared or treated to produce an activated surface for the electroless plating process. In some implementations, a metal seed layer may be deposited via different methods such as EL plating, physical vapor deposition (PVD), chemical vapor deposition (CVD), or atomic layer deposition (ALD), to serve as the activated surface upon which the electroless deposition may occur. In other implementations, a metal-immobilization process (MIP), such as a palladium-immobilization process (PIP) that is described below, may be used to form a metal catalyst layer that serves as the activated surface. The activated surface acts as a region that controls the placement of the electrolessly deposited cobalt or nickel metal alloy since the metal from the electroless plating solution deposits only on the activated surface.

In some implementations, a patterned photoresist mask may be used to define which areas of the substrate the metal layer becomes deposited. Conventional methods for depositing a photoresist material on the substrate and patterning the photoresist material to form a mask may be used. If the cobalt or nickel metal alloy magnetic layer is to be deposited using such a photoresist mask and a surface activation process as described above is also needed, the surface activation process does not occur on the areas covered with photoresist.

FIG. 2B illustrates a metal magnetic layer 212 formed on the IC die 200. For clarity, the entire IC die 200 is represented by a single box rather than the detailed structure shown in FIG. 2A. In accordance with implementations of the invention, the metal magnetic layer 212 consists of a metal alloy having one or both of cobalt and nickel. The metal magnetic layer 212 has a thickness between around 2 nm and 500 nm.

Next, an in situ nitridation process is used to convert a portion of the magnetic layer into a cobalt nitride (CoNₓ) or nickel nitride (NiNₓ) layer, which functions as an insulating layer (106 of FIG. 1). Cobalt nitride and nickel nitride are also paramagnetic materials. In an implementation of the invention, the in situ process may be carried out by exposing the magnetic layer to an amine or other nitrogen containing gas (106A). Amines that may be used here include, but are not limited to, N₂, NH₃, N₂O, triethylamine, hydrazines, and azides. The amine exposure takes place at a temperature between around 100° C. and around 400° C. In an alternate implementation, the amine exposure may occur by bubbling N₂ during the electroless plating deposition process.

In another implementation, the in situ nitridation process may be carried out by employing a plasma source to nitride the surface of the metal layer (106B). In accordance with an implementation of the invention, the plasma source may be a combination of argon and any of the above listed nitrogen-containing compounds (e.g., NH₃). The argon typically functions as a carrier gas. Other carrier gases that may be used include, but are not limited to, helium and xenon. The process parameters for the plasma application may include a flow rate of around 10 standard cubic centimeters per minute (SCCM) to around 100 SCCM, a pulse duration of around 1 second to around 20 seconds, and a plasma power between around 10 Watts (W) to around 200 W. A chuck upon which the substrate is mounted may be biased and capacitively-coupled. In further implementations, the in situ nitridation process may include both amine exposure and plasma exposure.

FIG. 2C illustrates an insulating layer 214 formed by converting a top portion of the metal layer 212. The insulating layer 214 consists of either CoNₓ or NiNₓ, in accordance with implementations of the invention. The insulating layer 214 has a thickness between around 1 nm and 300 nm. Since the insulating layer 214 was formed by converting a portion of the metal layer 212, the metal layer 212 now has a thickness between around 1 nm and 499 nm.

After the insulating layer is formed, a surface of the insulating layer is treated to enable the subsequent deposition of a metal layer on the insulating layer. Generally, it is very difficult to nucleate a metal onto an insulating layer such as a CoNₓ or NiNₓ layer. Therefore, in accordance with implementations of the invention, a metal-immobilization process (MIP) is carried out on the insulating layer (108 of FIG. 1). The MIP process uses a chelating group, also known as a coupling agent, to attach a metal seed layer onto the surface of the insulating layer. The metal seed layer then enables the subsequent deposition of a metal alloy layer containing one or both of cobalt and nickel using conventional metal deposition techniques.

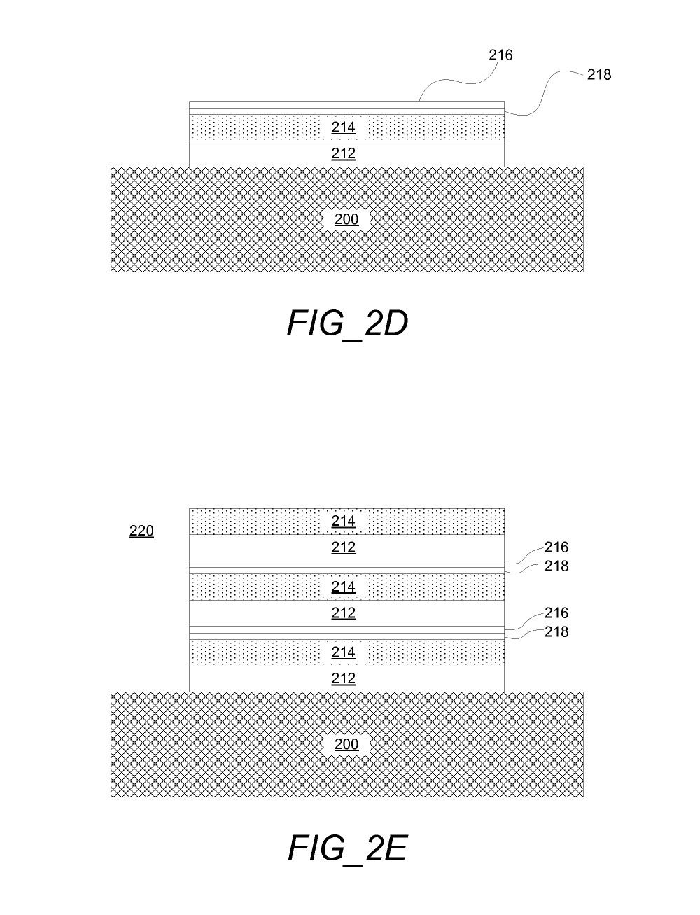

Turning to FIG. 3, an exemplary chelating group 300 is shown attached to the insulating layer 214. The chelating group 300 may include silicon, for instance, the chelating group 300 may include a silyl group 304, which has the ability to bond strongly to many different types of materials, including but not limited to an insulating layer such as a CoNₓ or NiNₓ layer. The chelating group 300 may also include a nitrogen group 306, which has the ability to bond to a metal. The nitrogen group 306 may be provided by an amine or an azo group. For instance, in the implementation shown, the chelating group 300 may be an azo-silyl moiety and the nitrogen group 306 may be provided by the azo group. A metal 308 may bond to the nitrogen 306 of the chelating group 300, such as palladium or iridium, that functions as a seed for a subsequent deposition of cobalt or nickel.

In one implementation of the invention, the chelating group is deposited directly on the insulating layer by exposing the insulating layer to a solution containing the chelating group. The exposure may be an immersion or a spray-on process. When the insulating layer is exposed to the solution containing the chelating group, the chelating group, including the azo-silyl moiety, attaches to the insulating layer with the silyloxy group bonded directly to the insulating layer and leaving the azo group exposed.

Next, the insulating layer may be exposed to a solution containing a metal. In implementations of the invention, the metal used here may include, but is not limited to, palladium, iridium, platinum, ruthenium, or osmium. Again, the exposure may be an immersion or a spray-on process. Here, the metal in solution becomes bonded to the nitrogen in the exposed azo group. This results in the formation of an adsorbed layer of a metal species over the chelating group.

After bonding to the insulating layer by way of the chelating group, the metal species layer may then immersed in an activation bath that contains a reducing agent. As is well known in the art, the oxidized metal is activated by being reduced in the activation bath. When activated, the metal center is electronically neutral and is in the metallic state. A layer of activated metal is now covalently bonded to the chelating group, thereby forming a monolayer of metal seed that is affixed to the surface of the insulating layer. The underlying nitrogen containing group acts as an immobilizing structure that holds the metal in place on the insulating layer.

FIG. 2D illustrates a metal seed layer 216 formed on the insulating layer 214. A thin monolayer of a chelating group 218 is present between the metal seed layer 216 and the insulating layer 214 to affix the metal seed layer 216 to the insulating layer 214. The metal seed layer 216 generally consists of palladium, iridium, platinum, ruthenium, or osmium metal. In accordance with implementations of the invention, the metal seed layer 216 has a thickness between around 1 nm and 5 nm.

The above described processes form one layer of the magnetic insulator nanolaminate device of the invention, namely a metal magnetic layer, an insulating layer, and a metal seed layer. If the magnetic insulator nanolaminate device has not reached a desired thickness, the above processes may be repeated to fabricate one or more additional layers of the magnetic insulator nanolaminate device until the desired thickness has been reached (110). For instance, another electroless plating process may be used to deposit a cobalt or nickel magnetic layer upon the metal seed layer, an in situ process may be used to convert a portion of the magnetic layer into an insulating layer, and an MIP process may be used to attach a metal seed layer to the insulating layer. In some implementations, the MIP process may not be necessary when the final magnetic insulator nanolaminate device layer is formed. When a sufficient number of layers have been fabricated and the magnetic insulator nanolaminate device has reached a desired thickness, the process may end (112).

FIG. 2E illustrates a magnetic insulator nanolaminate device 220 of the invention after the above described processes have been repeated to form multiple cobalt/nickel magnetic layers 212, multiple insulating layers 214, and an appropriate number of metal seed layers 216 and chelating group layers 218. In accordance with implementations of the invention, the completed magnetic insulator nanolaminate device 220 may have a thickness between around 1000 nm and 4000 nm. As shown, the chelating group layer 218 and the metal seed layer 216 may be omitted on the topmost insulating layer 214. And although the topmost layer shown in FIG. 2E is the insulating layer 214, in further implementations, the topmost layer may be the metal magnetic layer 212.

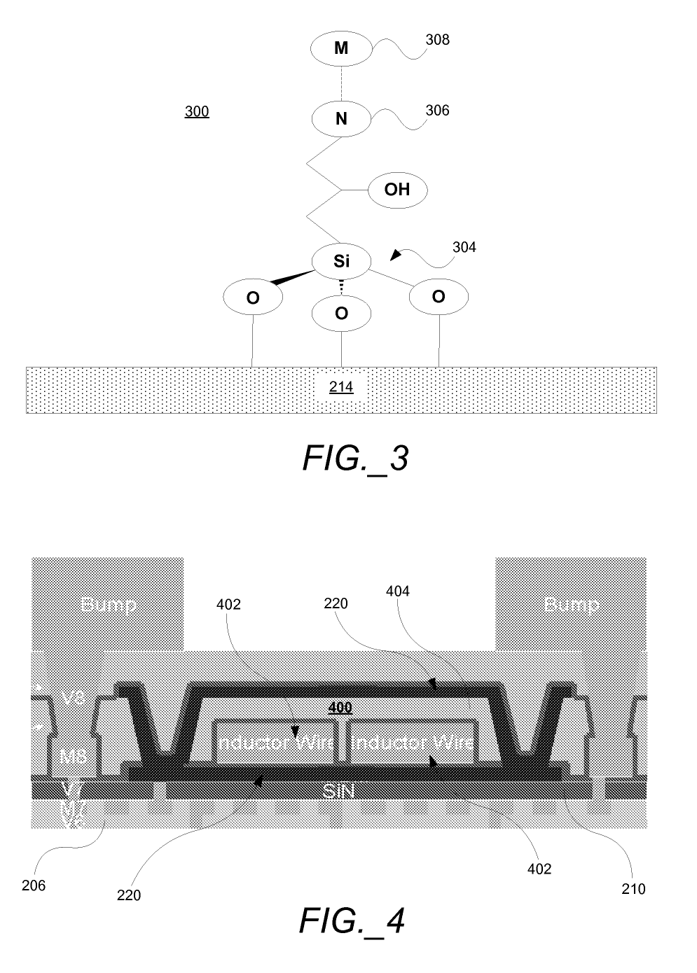

FIG. 4 illustrates how the magnetic insulator nanolaminate device 220 of the invention may be used to form an ISVR 400. As shown, a first magnetic insulator nanolaminate device layer 220 is formed on the passivation layer 210 of the IC die 200. Deposition of the magnetic insulator nanolaminate device layer 220 may occur through a photoresist mask, thereby enabling a “patterning” of the nanolaminate stack without the need for an etching process. One or more inductor wires 402 may be formed atop the first magnetic insulator nanolaminate device layer 220. Conventional metal deposition processes may be used to form the inductor wires 402. An insulating material 404, such as a dielectric material, may be formed to over the inductor wires 402. Finally, a second magnetic insulator nanolaminate device layer 220 may be formed over the inductor wires 402. Again, the deposition of the second magnetic insulator nanolaminate device layer 220 may occur through a photoresist mask to enable a patterning of the nanolaminate without the need for an etching process.

Accordingly, a magnetic insulator nanolaminate device for use in ISVR applications has been disclosed. The magnetic insulator nanolaminate device disclosed herein enables the deposition of magnetic layers within structures required for ISVR without eddy current issues. The magnetic layers and the insulating layers used in implementations of the invention use the same base materials, which minimizes process steps. Further, the processes described herein enable good control over layer composition and thickness and provide for repeatable deposition of magnetic and insulating layers.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

These modifications may be made to the invention in light of the above detailed description. The terms used in the following claims should not be construed to limit the invention to the specific implementations disclosed in the specification and the claims. Rather, the scope of the invention is to be determined entirely by the following claims, which are to be construed in accordance with established doctrines of claim interpretation.

1. A method of forming a magnetic insulator nanolaminate device comprising:
depositing a metal layer on a substrate;
converting a portion of the metal layer into an insulating layer using a nitridation process; and
depositing a metal seed layer onto the insulating layer using a metal immobilization process, wherein the metal seed layer enables the deposition of a metal layer onto the insulating layer.

2. The method of claim 1, further comprising repeating the processes of depositing a metal layer, converting a portion of the metal layer into an insulating layer, and depositing a metal seed layer until the magnetic insulator nanolaminate device has reached a desired thickness.

3. The method of claim 1, wherein an electroless plating process is used to deposit the metal layer on the substrate.

4. The method of claim 3, wherein a patterned photoresist mask is formed on the substrate to define which areas of the substrate the metal layer is deposited.

5. The method of claim 1, wherein the metal layer comprises a cobalt metal, a nickel metal, or a combination of cobalt and nickel metal.

6. The method of claim 1, wherein the insulating layer comprises cobalt nitride, nickel nitride, or a combination of cobalt nitride and nickel nitride.

7. The method of claim 1, wherein the nitridation process comprises exposing the metal layer to a nitrogen containing gas.

8. The method of claim 7, wherein the nitrogen containing gas is selected from the group consisting of N₂, NH₃, N₂O, triethylamine, hydrazines, and azides.

9. The method of claim 1, wherein the nitridation process comprises applying a plasma to the metal layer.

10. The method of claim 9, wherein the plasma comprises a carrier gas in combination with a nitrogen-containing compound selected from the group consisting of N₂, NH₃, N₂O, triethylamine, hydrazines, and azides.

11. The method of claim 1, wherein the metal seed layer comprises a metal selected from the group consisting of palladium, iridium, platinum, ruthenium, and osmium.

12. The method of claim 1, wherein the metal immobilization process comprises:
depositing a chelating group layer onto the insulating layer;
adsorbing a metal species layer onto the chelating group layer; and
reducing the metal species layer to form the metal seed layer.

13. A magnetic insulator nanolaminate device comprising:
a metal magnetic layer formed on a substrate;
an insulating layer formed on the metal magnetic layer, wherein the insulating layer is formed by nitriding a portion of the metal magnetic layer;
a chelating group layer formed on the insulating layer; and
a metal seed layer bonded to the chelating group layer.

14. The device of claim 13, wherein the metal magnetic layer comprises a metal selected from the group consisting of cobalt and nickel.

15. The device of claim 13, wherein the insulating layer comprises a material selected from the group consisting of cobalt nitride and nickel nitride.

16. The device of claim 13, wherein the metal seed layer comprises a metal selected from the group consisting of palladium, iridium, platinum, ruthenium, and osmium.

17. The device of claim 13, wherein the device comprises multiple metal magnetic layers, multiple insulating layers, and an appropriate number of chelating group layers and metal seed layers to couple the metal magnetic layers to the insulating layers.
